(19) United States
(12) Patent Application Publication
(10) Pub. No.: US 2011/0047754 A1
(43) Pub. Date: Mar. 3, 2011

(54) HINGE DEVICE AND APPARATUS USING HINGE DEVICE

(76) Inventor: Daisuke TAKAHASHI, Tokyo (JP)

(21) Appl. No.: 12/612,922

(22) Filed: Nov. 5, 2009

(30) Foreign Application Priority Data
Aug. 28, 2009 (JP) 2009-198642

(51) Int. Cl. E05D 11/08

(52) U.S. Cl. 16/342

(57) ABSTRACT

A hinge device includes a cylindrical space between a hinge tube and a hinge shaft, and a cylindrical body fitted to the cylindrical space. The hinge device further includes a recessed portion formed at an end edge of the cylindrical body, stepped portions formed at both ends of the recessed portion in a circumferential direction, and a pin. The hinge tube and the cylindrical body generate rotational friction resistance by a relative rotation thereof. The cylindrical body rotates relative to the hinge shaft. The pin is situated in the recessed portion. The pin contacts with either of the stepped portions by a relative rotation of the hinge shaft and the cylindrical body.

### BACKGROUND OF THE INVENTION AND RELATED ART STATEMENT

The present invention relates to a hinge device that is used in a foldable opening/closing device such as a personal computer and the like, and an apparatus using the hinge device.

In the foldable opening/closing device such as the personal computer and the like, an opening angle of a display unit is set to various angles by different users. Therefore, a hinge device including a free stop mechanism is used, so that the free-stop mechanism can keep the display unit at a position corresponding to any opening angle. As this kind of the hinge device, Patent References 1 and 2 disclose conventional hinge devices with a hinge shaft inserted into a hinge tube. In the conventional hinge devices, rotational friction resistance is generated between the hinge shaft and the hinge tube.

### Patent Reference 1: Japanese Utility Model Publication No. 03-050178

### Patent Reference 2: Japanese Patent Publication No. 08-121009

According to Patent References 1 and 2, the following devices have been proposed as the conventional hinge devices that generate the rotational friction resistance between the hinge shaft and the hinge tube. In Patent reference 1, a hinge shaft is formed to have an elliptical cross section, and a hinge tube has a circular shape in an inner surface thereof. Further, a gradually swelled wall portion is formed in the hinge tube. As the hinge shaft is rotated, an outer circumference surface of the hinge shaft slides on the gradually swelled wall portion, so that the rotational friction resistance is gradually increased.

In Patent Reference 2, a hinge shaft is formed to have an elliptical cross section and a hinge tube has a circular shape in an inner surface thereof. Further, a stepped portion is formed in the hinge tube. An inner diameter of the stepped portion is continuously changed. As the hinge shaft is rotated, the outer circumference surface of the hinge shaft slides on the stepped portion, so that the rotational friction resistance is gradually increased.

In the conventional hinge devices, the gradually swelled wall portion or the stepped portion having the inner diameter changed continuously is formed in the hinge tube. Accordingly, it is necessary to form the gradually swelled wall portion and the stepped portion having the inner diameter changed continuously inside the hinge tube separately.

In view of the problems described above, an object of the present invention is to provide a hinge device capable of generating rotational torque according to a rotational angle with a simple structure without forming a gradually swelled wall portion or a stepped portion having an inner diameter changed continuously separately in a hinge tube.

### SUMMARY OF THE INVENTION

In order to attain the objects described above, according to a first aspect of the present invention, a hinge device includes a hinge shaft being inserted into a hinge tube thereof, so that rotational friction resistance is generated by a relative rotation of the hinge tube and the hinge shaft. The hinge device further includes a cylindrical space that is formed between the hinge tube and the hinge shaft; a cylindrical body that is fitted to the cylindrical space; a recessed portion that is formed at an end edge portion of the cylindrical body; stepped portions that are formed at both ends of the recessed portion in a circumferential direction; and a pin that is provided on the hinge shaft. The hinge tube and the cylindrical body are provided so as to generate rotational friction resistance by the relative rotation thereof. The cylindrical body and the hinge shaft are provided so as to rotate relative to each other. The pin of the hinge shaft is situated in the recessed portion of the cylindrical body. Further, the pin comes in contact with one of the stepped portions by a relative rotation of the hinge shaft and the cylindrical body.

According to a second aspect of the present invention, a hinge device includes a hinge shaft being inserted into a hinge tube thereof, so that rotational friction resistance is generated by a relative rotation of the hinge tube and the hinge shaft. The hinge device further includes a sub-hinge shaft that is provided at one end of the hinge shaft. The recessed portion is formed at one of the hinge shaft and the sub-hinge shaft, facing the other of the hinge shaft and the sub-hinge shaft. The recessed portion includes stepped portions at both ends thereof in a circumferential direction. Further, a pin is provided at the other of the hinge shaft and the sub-hinge shaft, facing the one of the hinge shaft and the sub-hinge shaft.

In the second aspect of the present invention, the hinge tube and the hinge shaft are provided so as to generate rotational friction resistance by a relative rotation thereof. Further, the hinge tube and the sub-hinge shaft are provided so as to generate rotational friction resistance by a relative rotation thereof. The pin is situated in the recessed portion and situated at a position where the pin comes in contact with either of the stepped portions by the relative rotation of the hinge tube and the hinge shaft.

According to a third aspect of the present invention, an apparatus includes the hinge device between a main body portion including an operating unit and the like and a rotating portion including a display unit and the like.

In the first aspect of the present invention, the cylindrical body is rotated together with the hinge tube by the relative rotation of the hinge tube and the hinge shaft first. Then, when the pin comes in contact with either of the stepped portions of the cylindrical body, the cylindrical body is rotated together with the pin as the hinge shaft is rotated relative to the hinge tube.

When the cylindrical body is rotated together with the pin, the cylindrical body is rotated relative to the hinge tube and the rotational friction resistance is generated between the cylindrical body and the hinge tube. Accordingly, when the relative rotation occurs between the hinge tube and the hinge shaft, the cylindrical body is rotated together with the hinge tube. Thereby, the hinge shaft is rotated relative to the cylindrical body. Subsequently, when the pin comes in contact with either of the stepped portions of the cylindrical body, the cylindrical body is rotated together with the pin. When the cylindrical body is rotated together with the pin, the cylindrical body is rotated relative to the hinge tube. Thereby, the rotational friction resistance is generated between the cylindrical body and the hinge tube.

Therefore, the hinge device has a “first rotation range of the hinge shaft” where the pin of the hinge shaft is relatively rotated between the stepped portions of the recessed portion of the cylindrical body by the relative rotation of the hinge tube and the hinge shaft. Further, the hinge device has a “second rotation range of the hinge shaft” where the pin in the state of being in contact with either of the stepped portions of the recessed portion, is rotated together with the cylindrical body.

In the first rotation range, the rotational friction resistance of the hinge device is composed of the rotational resistance generated between the hinge shaft and the hinge tube only. On the other hand, in the second rotation range, the rotational resistance of the hinge device is composed of the rotational resistance generated between the cylindrical body and the hinge tube, in addition to the rotational resistance generated in the first rotation range.

In the second aspect of the present invention, the rotational friction resistance is generated by the relative rotation of the hinge tube and the hinge shaft. The sub-hinge shaft is rotated together with the hinge tube. Further, when the relative rotation of the hinge shaft and the hinge tube is progressed, the pin comes in contact with either of the stepped portions. Accordingly, the sub-hinge shaft is rotated together with the hinge shaft.

When the sub-hinge shaft is rotated together with the hinge shaft, the rotational friction resistance is generated between the hinge tube and the sub-hinge shaft. Accordingly, when relative rotation occurs between the hinge tube and the hinge shaft, the sub-hinge shaft is rotated together with the hinge tube. Further, when the pin comes in contact with either of the stepped portions, the sub-hinge shaft is rotated together with the hinge shaft. Thereby, the hinge tube is rotated relative to the sub-hinge shaft and the rotational friction resistance is generated therebetween.

Therefore, the hinge device has a “first rotation range of the hinge shaft”, where the pin relatively rotates between the stepped portions of the recessed portion by the relative rotation of the hinge tube and the hinge shaft. Furthermore, the hinge device has a “second rotation range of the hinge shaft” where the pin in the state of being in contact with either of the stepped portions of the recessed portion, rotates together with the sub-hinge shaft.

In the first rotation range, the rotational friction resistance of the hinge device is composed of the rotational resistance generated between the hinge shaft and the hinge tube only. On the other hand, in the second rotation range, the rotational friction resistance of the hinge device is composed of the rotational resistance generated between the sub-hinge shaft and the hinge tube, in addition to the rotational resistance generated in the first rotation range.

As described above, according to the hinge device of the present invention, it is possible to obtain the hinge device capable of providing different torque in different rotation ranges with the simple structure. Accordingly, it is not required to form a wall portion swelling gradually or a stepped portion being continuously changed separately, as opposed to a conventional hinge device. Further, according to the present invention, it is be possible to obtain the apparatus furnished with the improved hinge device.

### BRIEF DESCRIPTION OF THE DRAWINGS

FIG. 1 is a perspective view showing a hinge device used in a mobile telephone according to a first embodiment of the present invention;

FIG. 2 is a perspective view showing the hinge device used in a laptop personal computer according to the first embodiment of the present invention;

FIG. 3 is a perspective view showing the hinge device according to the first embodiment of the present invention;

FIG. 4 is an exploded perspective view showing the hinge device according to the first embodiment of the present invention;

FIGS. 5(a) and 5(b) are sectional views showing the hinge device according to the first embodiment of the present invention, wherein FIG. 5(a) is a sectional view showing the hinge device including a cylindrical body, and FIG. 5(b) is a sectional view showing a cylindrical space of the hinge device without the cylindrical body;

FIGS. 6(a), 6(b) and 6(c) are partially cut-out perspective views showing the hinge device according to the first embodiment of the present invention, sequentially illustrating states where a hinge shaft is operated;

FIGS. 7(a), 7(b), and 7(c) are partially cut-out side views showing the hinge device according to the first embodiment of the present invention, sequentially illustrating the states where the hinge shaft is operated;

FIGS. 8(a), 8(b), and 8(c) are side views showing an apparatus according to the first embodiment of the present invention, sequentially illustrating states where a rotating portion is operated;

FIG. 9 is a perspective view showing a connecting portion of the hinge shaft and a pin fitted to the connecting portion according to the first embodiment of the present invention;

FIG. 10 is a perspective view showing the connecting portion of the hinge shaft and a pin protruding from the connecting portion according to the first embodiment of the present invention;

FIG. 11 is a partially cut-out side view showing the hinge device with the pin shown in FIG. 10 according to the first embodiment of the present invention;

FIG. 12 is a partially cut-out perspective view showing the hinge device with the pin shown in FIG. 10 according to the first embodiment of the present invention;

FIGS. 13(a), 13(b) and 13(c) are partially cut-out side views showing the hinge device according to the first embodiment of the present invention, sequentially illustrating states where the hinge shaft is operated;

FIG. 14 is an exploded perspective view showing a hinge device according to a second embodiment of the present invention; and

FIG. 15 is an exploded perspective view showing a modified example of the hinge device according to the second embodiment of the present invention.

### DETAILED DESCRIPTION OF THE PREFERRED EMBODIMENT

Hereunder, embodiments of the present invention will be explained with reference to the accompanying drawings.

### First Embodiment

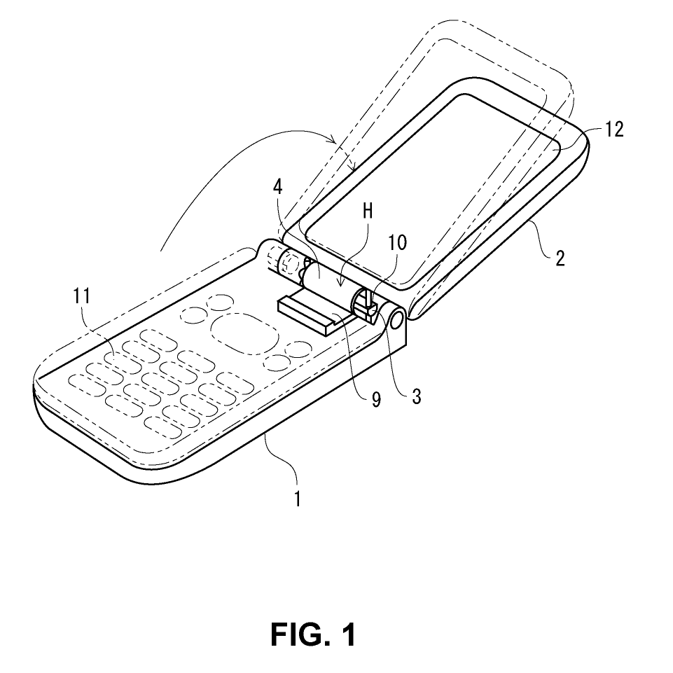

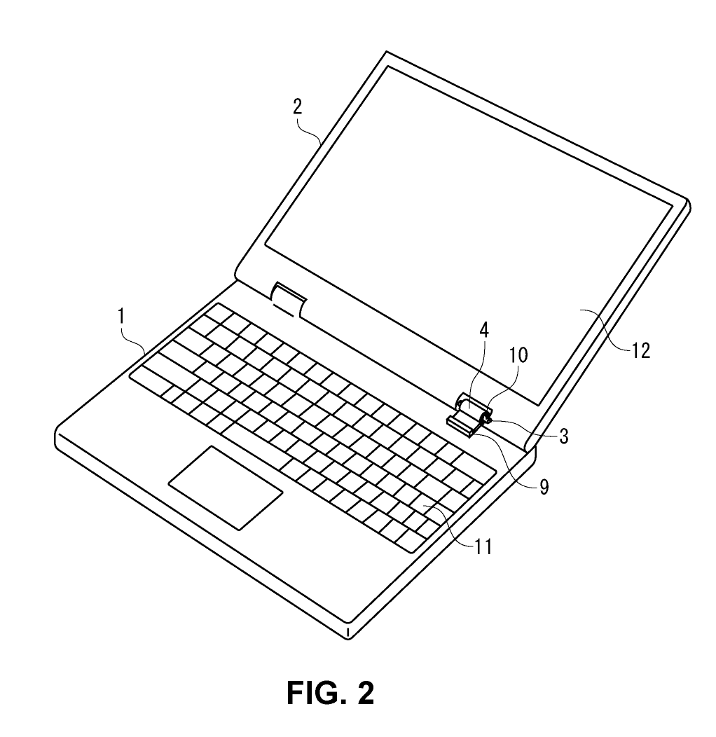

A first embodiment of the present invention will be explained. FIG. 1 is a perspective view showing a hinge device H used in a mobile telephone according to the first embodiment. FIG. 2 is a perspective view showing the hinge device H used in a laptop personal computer according to the first embodiment.

As shown in FIGS. 1 and 2, the hinge device H is used in the apparatus. In the apparatus, a rotating portion 2 including a display unit 12 is rotated with respect to a main body portion 1 including an operating unit 11. In the hinge device H, a hinge shaft 3 is inserted into a hinge tube 4. Rotational friction resistance is generated by a relative rotation of the hinge tube 4 and the hinge shaft 3.

In the embodiment, a connecting unit 9 extends from the hinge tube 4, and the connecting unit 9 is connected to the main body portion 1. Further, end portions of the hinge shaft 3 are extended outside the hinge tube 4, thereby forming connecting portions 10. The connecting portions 10 are connected to the rotating portion 2.

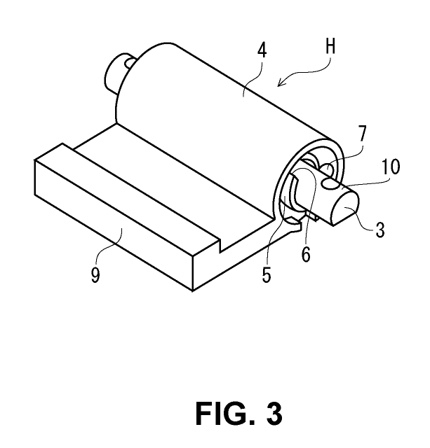

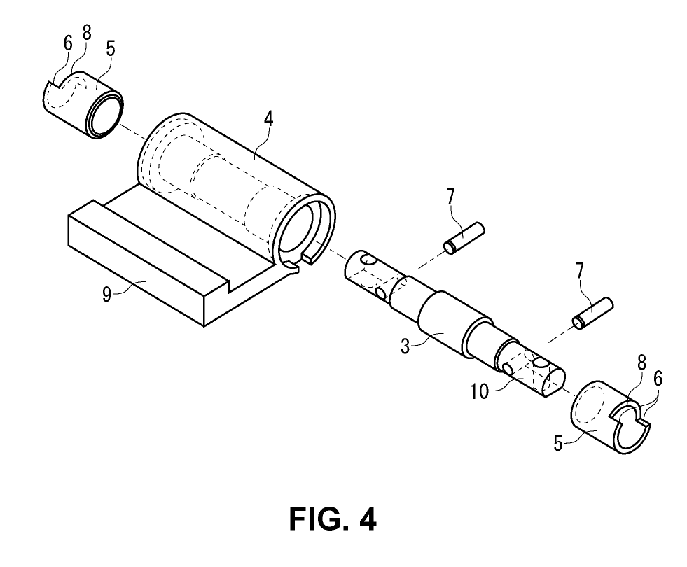

Furthermore, as shown in FIGS. 3, 4, 5(a) and 5(b), according to the embodiment, when the hinge shaft 3 is inserted into the hinge tube 4, a cylindrical space 50 is formed between the hinge tube 4 and the hinge shaft 3 of the hinge device H.

A cylindrical body 5 is fitted to the cylindrical space 50. The cylindrical body 5 is provided so as to rotate freely with respect to the hinge shaft 3, while the cylindrical body 5 generates a rotational friction resistance against the hinge tube 4 by a relative rotation with the hinge tube 4.

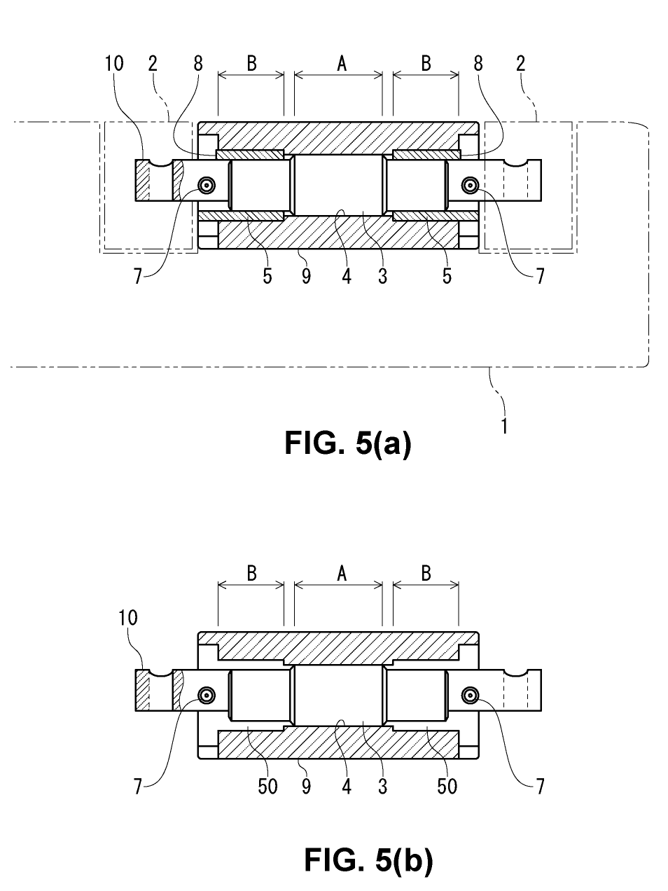

Meanwhile, a rotational friction resistance is generated at a portion corresponding to a distance A shown in FIGS. 5(a) and 5(b) by a relative rotation of the hinge tube 4 and the hinge shaft 3. Further, the cylindrical body 5 and the hinge shaft 3 are provided so as to rotate freely with respect to each other, and the rotational friction resistance is generated at portions corresponding to distances B shown in FIGS. 5(a)-5(b) by the relative rotation of the cylindrical body 5 and the hinge tube 4.

The cylindrical body 5 includes a recessed portion 8 at an end edge thereof. Further, the recessed portion 8 includes stepped portions 6 at both ends thereof in a circumferential direction thereof.

In addition, the hinge shaft 3 includes a pin 7. The pin 7 is located in the recessed portion 8 of the cylindrical body 5. In addition, the pin 7 is situated at a position where the pin 7 comes in contact with either of the stepped portions 6 by the relative rotation of the hinge shaft 3 and the cylindrical body 5.

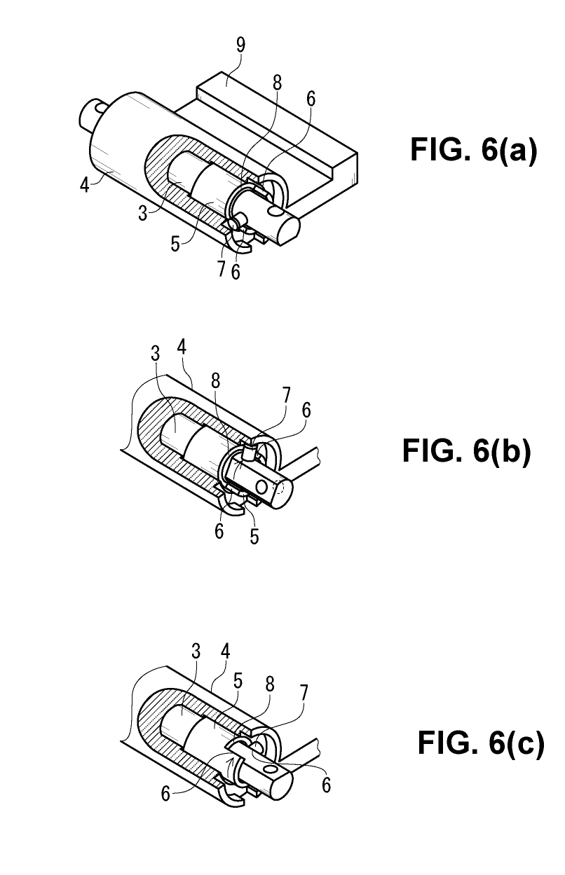

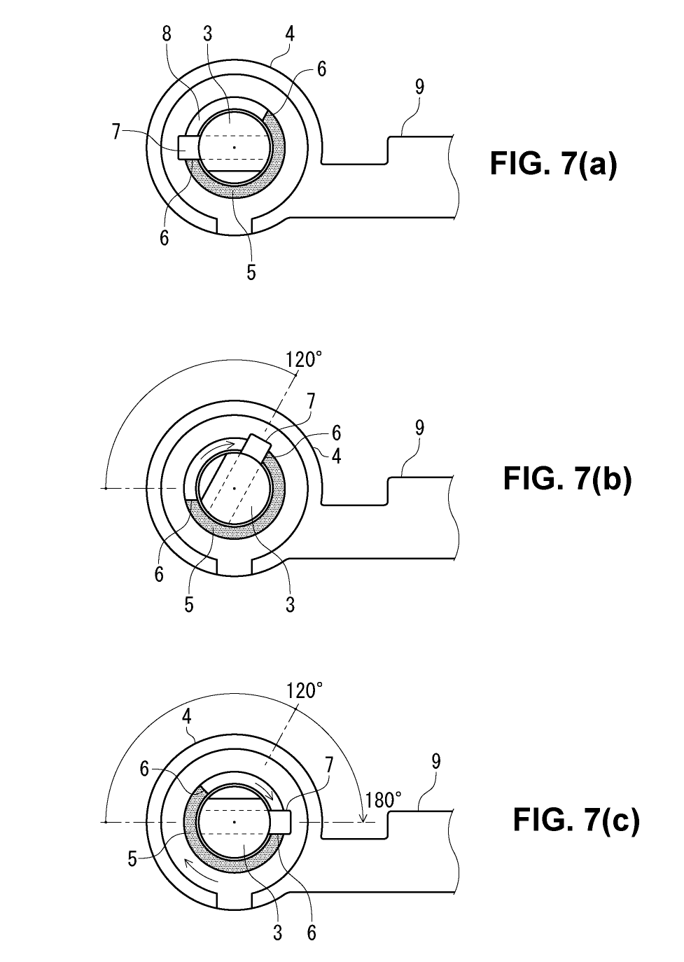

According to the embodiment, in the hinge device H structured as described above, the relative rotation of the hinge shaft 3 and the hinge tube 4 generates the rotational friction resistance in a range of 120 degree. In other words, the relative rotation of the hinge shaft 3 and the hinge tube 4 generates the rotational friction resistance upon rotating from the position where the pin 7 comes in contact with one of the stepped portions 6 of the cylindrical body 5 as shown in FIGS. 6(a) and 7(a) to the position where the pin 7 comes in contact with the other of the stepped portions 6 as shown in FIGS. 6(b) and 7(b). In this case, the cylindrical body 5 is rotated together with the hinge tube 4.

Further, in the embodiment, when the hinge shaft 3 rotates from the position shown in FIGS. 6(b) and 7(b) to a position shown in FIGS. 6(c) and 7(c), that is, from the position corresponding to 120 degree to a position corresponding to 180 degree, the pin 7 is rotated together with the cylindrical body 5. Thereby, the cylindrical body 5 is rotated relative to the hinge tube 4. As a result, the rotational friction resistance is generated between the cylindrical body 5 and the hinge tube 4.

In the embodiment described above, the rotational friction resistance is generated between the position corresponding to 0 degree and the position corresponding to 120 degree (a first rotation range of the hinge shaft 3) by the relative rotation of the hinge tube 4 and the hinge shaft 3. Furthermore, the rotational friction resistance by the relative rotation of the hinge tube 4 and the cylindrical body 5 is further added between the position corresponding to 120 degree and the position corresponding to 180 degree (a second rotation range of the hinge shaft 3).

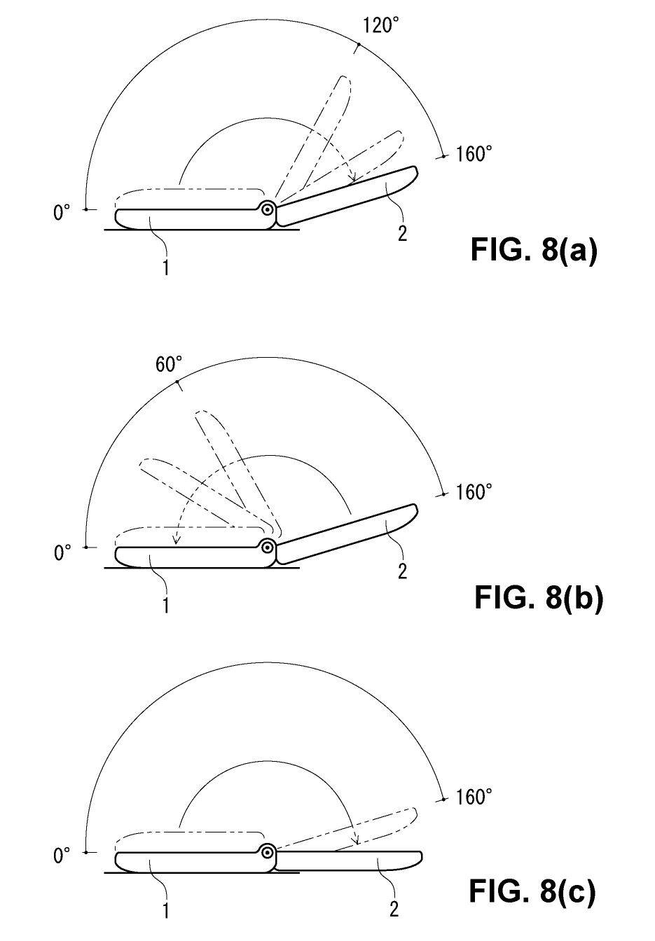

Further, when a situation shown with a projective line in FIG. 8(a), that is, the rotating portion 2 is situated over the main body portion 1, is compared to situations shown in FIGS. 6(c) and 7(c), a predetermined rotational friction resistance is generated since the situation is in the first rotation range of the hinge shaft 3 as far as the rotating portion 2 is opened at an angle between 0 degree and 120 degree. Furthermore, as shown with solid lines in FIGS. 8(b) and 8(c), when the angle of the rotating portion 2 exceeds 120 degree, the rotational friction resistance is further generated and added since the situation shifts to the second rotation range of the hinge shaft 3. Consequently, a free stop action works, thereby keeping the display unit or the rotating portion 2 at a desired position.

When the rotating portion 2 shown with a solid line in FIG. 8(c) is rotated and put over the main body portion 1, the rotational friction resistance is further generated as the rotating portion 2 reaches a position corresponding to 60 degree shown with the projected line in FIG. 8(b). Thus the rotational friction resistance works as a rotation stopper for the rotating portion 2. Accordingly, it is possible to prevent the display unit or the rotating portion 2 from closing rapidly toward the main body portion 1.

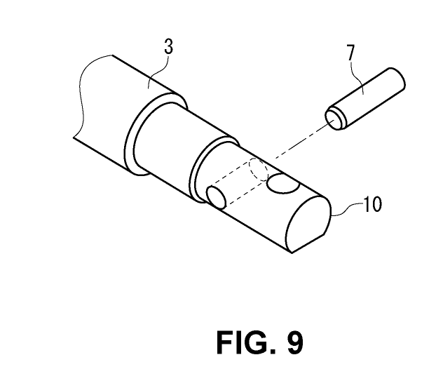

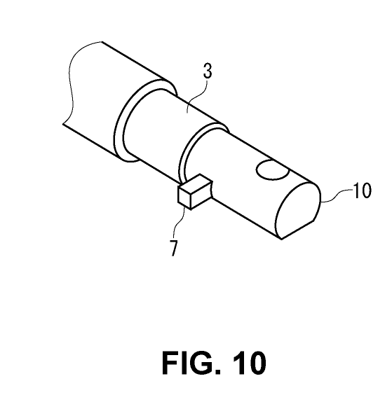

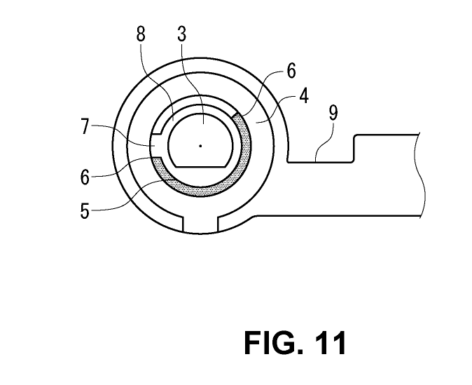

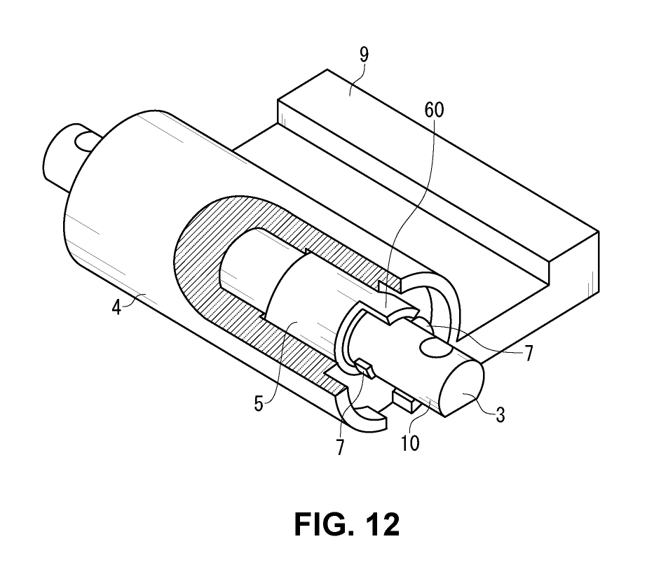

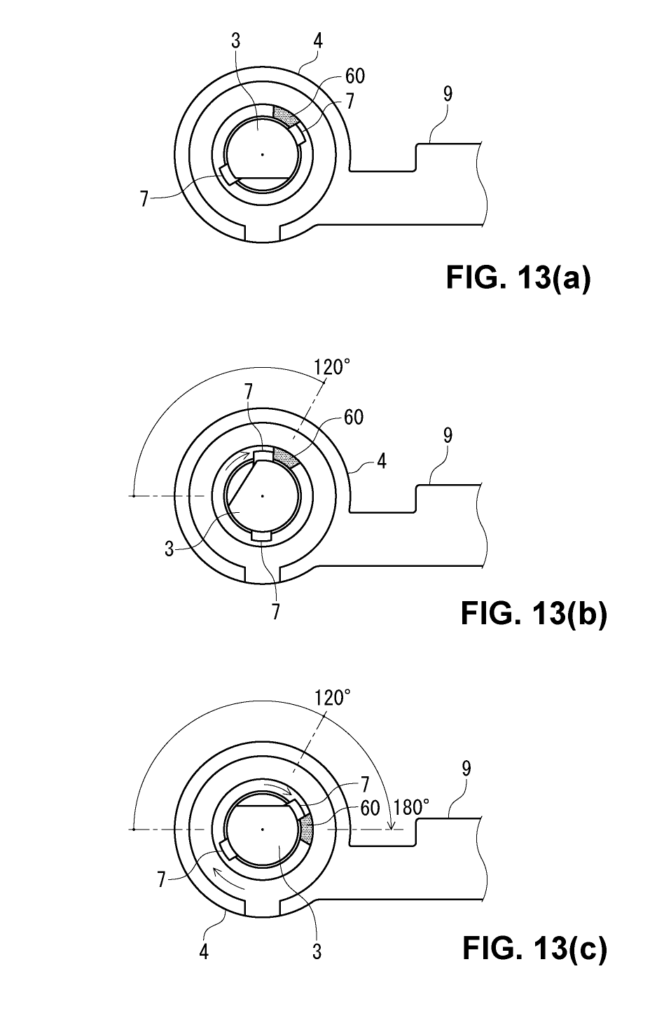

In the embodiment, as shown in FIG. 9, the pin 7 of the hinge device H is formed separately from the hinge shaft 3. The pin 7 may be formed integrally with the hinge shaft 3 as shown in FIGS. 10 and 11. Further, a plurality of the pins 7 may be formed as shown in FIGS. 12 and 13. Alternatively, a contact portion 60 may be formed at the cylindrical body 5 and the pin 7 may contact with the contact portion 60.

As shown in FIGS. 12 and 13, when the contact portion 60 is formed at the cylindrical body 5, a portion where the contact portion 60 is not formed corresponds to the recessed portion 8 and both sides of the contact portion 60 correspond to the stepped portions 6. Accordingly, when the contact portion 60 is formed at the cylindrical body 5, the hinge device has a similar structure with the embodiment described above and provides the same operational effect as the embodiment described above.

### Second Embodiment

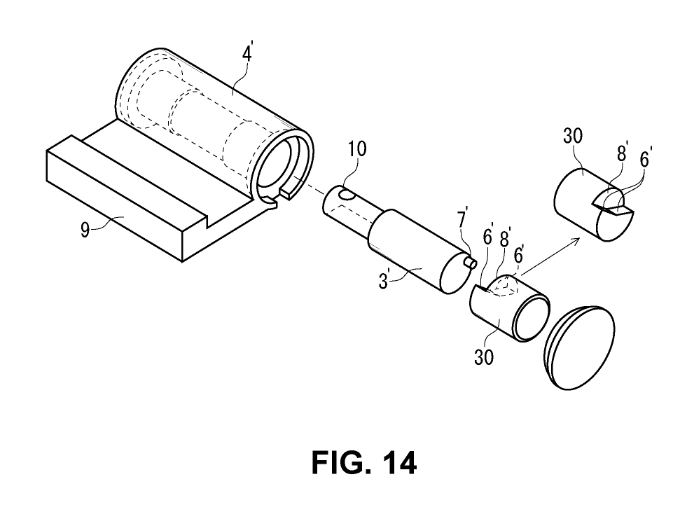

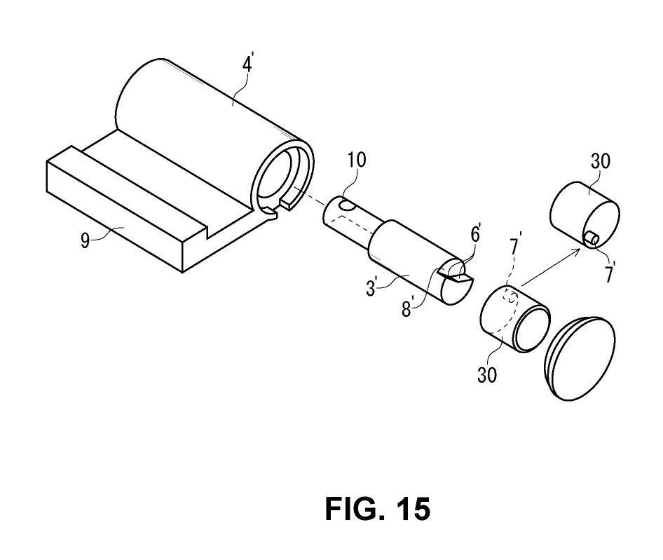

A second embodiment of the present invention will be explained next. FIGS. 14 and 15 are views showing a hinge device H′ according to the second embodiment of the present invention. Similar to the first embodiment, the hinge device H′ includes a hinge shaft 3′ inserted into a hinge tube 4′ thereof. Further, the hinge device H′ generates a rotational friction resistance by a relative rotation of the hinge tube 4′ and the hinge shaft 3′.

In the embodiment, the hinge device H′ includes a sub-hinge shaft 30 at one end of the hinge shaft 3′. The sub-hinge shaft 30 is fitted to the hinge tube 4′ and is situated on the same axis as an axis of the hinge shaft 3′.

In the embodiment, the hinge tube 4′ and the hinge shaft 3′ are provided so as to generate the rotational friction resistance by the relative rotation thereof. In addition, the hinge tube 4′ and the sub-hinge shaft 30 are provided so as to generate rotational friction resistance by a relative rotation thereof.

Further, a recessed portion 8′ is formed in one of the hinge shaft 3′ and the sub-hinge shaft 30. The recessed portion 8′ faces the other of the hinge shaft 3′ and the sub-hinge shaft 30. Further, a pin 7′ is provided at the other of the hinge shaft 3′ and the sub-hinge shaft 30. Stepped portions 6′ are formed at both ends of the recessed portion 8′ in a circumferential direction.

Further, the pin 7′ is situated in a position where the recessed portion 8′ is situated. Further, the pin 7′ is situated where the pin 7′ comes in contact with either of the stepped portions 6′ by the relative rotation of the hinge shaft 3′ and the hinge tube 4′.

In the embodiment shown in FIG. 14, the pin 7′ is provided at the hinge shaft 3′, and the recessed portion 8′ is formed at the sub-hinge shaft 30 while the recessed portion 8′ is formed at the hinge shaft 3′ and the pin 7′ is provided at the sub-hinge shaft 30 in FIG. 15.

As shown in FIGS. 14 and 15, the hinge device H′ generates the rotational friction resistance by the relative rotation of the hinge tube 4′ and the hinge shaft 3′. In this case, the sub-hinge shaft 30 is rotated together with the hinge tube 4′. Further, when the relative rotation of the hinge shaft 3′ and the hinge tube 4′ progresses, the pin 7′ comes in contact with either of the stepped portions 6′. Thereby, the sub-hinge shaft 30 is rotated together with the hinge shaft 3′.

When the sub-hinge shaft 30 is rotated together with the hinge shaft 3′, the rotational friction resistance is generated between the hinge tube 4′ and the sub-hinge shaft 30. Accordingly, in the embodiment, the sub-hinge shaft 30 is rotated together with the hinge tube 4′ when the relative rotation occurs between the hinge tube 4′ and the hinge shaft 3′. Subsequently, when the pin 7′ comes in contact with either of the stepped portions 6′, the sub-hinge shaft 30 is rotated together with the hinge shaft 3′. Thereby, the hinge tube 4′ is rotated relative to the sub-hinge shaft 30 and the rotational friction resistance is generated between the hinge tube 4′ and the sub-hinge shaft 30.

Therefore, in the embodiment, the hinge device H′ has a “first rotation range of the hinge shaft 3′”, where the pin 7′ relatively rotates between one and the other of the stepped portions 6′ of the recessed portion 8′ by the relative rotation of the hinge tube 4′ and the hinge shaft 3′. Furthermore, the hinge device H′ has a “second rotation range of the hinge shaft 3′” where the pin 7′ rotates together with the sub-hinge shaft 30 as the pin 7′ is in contact with either of the stepped portions 6′ of the recessed portion 8′.

In the first rotation range, the rotational friction resistance of the hinge device H′ is composed of the rotational resistance generated between the hinge shaft 3′ and the hinge tube 4′ only. In the second rotation range, the rotational friction resistance of the hinge device H′ is composed of the rotational resistance generated between the sub-hinge shaft 30 and the hinge tube 4′, adding to the rotational resistance generated in the first rotation range.

According to the embodiments described above, for example, the hinge device in the first embodiment includes two cylindrical bodies. The number of the cylindrical bodies is not limited to two. Only one cylindrical body may be used. Further, according to the embodiment shown in FIGS. 12 and 13, one cylindrical body 5 is provided though two cylindrical bodies 5 may be used. As described above, the present invention is not limited to the above-mentioned embodiments and may be appropriately modified as far as the modifications fit to the gist of the present invention.

As described above, according to the present invention, it is possible to obtain a hinge device capable of providing different torque in different rotation ranges by a simple structure. Accordingly, it is not required to form a wall portion swelling gradually or a stepped portion being continuously changed separately, while the conventional hinge device is required to form. Further, according to the present invention, it is possible to obtain an apparatus furnished with an improved hinge device.

The hinge device according to the present invention is aimed for a personal computer and the like. The hinge device also may be applied to general items that require a free stop for opening, closing or rotation thereof, such as a makeup compact, a door, a toilet lid, and the like.

The disclosure of Japanese Patent Application No. 2009-198642, filed on Aug. 28, 2009 is incorporated in the application by reference.

While the invention has been explained with reference to the specific embodiments of the invention, the explanation is illustrative and the invention is limited only by the appended claims.

What is claimed is:

1. A hinge device comprising:
a hinge tube;
a hinge shaft inserted into the hinge tube for generating rotational friction resistance when the hinge shaft rotates relative to the hinge tube;
a cylindrical space formed between the hinge tube and the hinge shaft;
a cylindrical body fitted in the cylindrical space for generating rotational friction resistance when the cylindrical body rotates relative to the hinge tube, said cylindrical body being arranged to rotate freely relative to the hinge shaft;
a recessed portion formed at an end edge of the cylindrical body;
a stepped portion formed at an end portion of the recessed portion in a circumferential direction; and
a pin provided at the hinge shaft, said pin being situated in the recessed portion so that the pin contacts with the stepped portion when the hinge shaft rotates relative to the cylindrical body.

2. A hinge device comprising:
a hinge tube;
a hinge shaft inserted into the hinge tube for generating rotational friction resistance when the hinge shaft rotates relative to the hinge tube;
a sub-hinge shaft provided at one end of the hinge shaft for generating rotational friction resistance when the sub-hinge shaft rotates relative to the hinge tube;
a recessed portion formed at one of the hinge shaft and the sub-hinge shaft to face the other of the hinge shaft and the sub-hinge shaft;
a stepped portion formed at an end portion of the recessed portion in a circumferential direction; and
a pin provided at the other of the hinge shaft and the sub-hinge shaft, said pin being situated in the recessed portion so that the pin contacts with the stepped portion when the hinge shaft rotates relative to the hinge tube.

3. An apparatus comprising a main body portion including an operating unit, a rotating portion including a display unit, and the hinge device according to claim 1 disposed between the main body and the rotating portion.

4. An apparatus comprising a main body portion including an operating unit, a rotating portion including a display unit, and the hinge device according to claim 2 disposed between the main body and the rotating portion.
